(19) United States
(12) Patent Application Publication
(10) Pub. No.: US 2011/0254338 A1
(43) Pub. Date: Oct. 20, 2011

(54) MULTI-PAWL ROUND-RECLINER MECHANISM

(76) Inventors: Alfred J. FISHER, III, Grosse Pointe, MI (US); John J. Berndtson, Grosse Pointe Woods, MI (US); David W. Milodrowski, Clinton Township, MI (US)

(21) Appl. No.: 13/099,594

(22) Filed: May 3, 2011

Related U.S. Application Data
(63) Continuation of application No. PCT/US2009/033067, filed on Feb. 4, 2009.
Application No. PCT/US2009/033067 is a continuation of application No. PCT/EP2009/033067, filed on Feb. 4, 2009.
(60) Provisional application No. 61/026,352, filed on Feb. 5, 2008.
(60) Provisional application No. 61/026,352, filed on Feb. 5, 2008.

(51) Int. Cl. A47C 1/026; B60N 2/235

(52) U.S. Cl. 297/367 P

(57) ABSTRACT

A recliner mechanism may include a first plate, a second plate, and a locking mechanism associated with the first plate and the second plate. The locking mechanism may be movable between an unlocked state permitting relative movement between the first plate and the second plate and a locked state restricting relative movement between the first plate and the second plate. The locking mechanism may include at least five pawls that are movable between a first position and a second position to move the locking mechanism between the unlocked state and the locked state.

### CROSS-REFERENCE TO RELATED APPLICATIONS

This application is a continuation of copending international patent application PCT/EP2009/033067 filed on Feb. 4, 2009 and claims the benefit of U.S. Ser. No. 61/026,352, filed on Feb. 5, 2008. The entire contents of these priority applications are incorporated herein by reference.

### FIELD

The present disclosure relates to recliner mechanisms and more particularly to a multi-pawl round-recliner mechanism.

### BACKGROUND

The statements in this section merely provide background information related to the present disclosure and may not constitute prior art.

Recliner mechanisms are conventionally used in seat assemblies to permit selective adjustment of a seatback relative to a seat bottom. One such recliner mechanism is a round-recliner mechanism, which typically includes a guide plate fixed to a seat bottom, a ratchet plate attached to a seatback, and a locking mechanism disposed generally between the guide plate and ratchet plate. The locking mechanism selectively prevents rotation of the ratchet plate relative to the guide plate and, thus, selectively prevents rotation of the seatback relative to the seat bottom.

While conventional round-recliner mechanisms adequately prevent movement of a seatback relative to a seat bottom when in a locked state and permit movement of a seatback relative to a seat bottom when in an unlocked state, conventional round-recliner mechanisms are typically bulky and, as such, increase the cost and weight of a seat assembly. Further, conventional round-recliner mechanisms are generally expensive to manufacture due to the thicknesses of the materials used and the offal (i.e., scrap) produced as a result of manufacturing the individual components of the round-recliner mechanism.

### SUMMARY

A recliner mechanism is provided and may include a first plate, a second plate, and a locking mechanism associated with the first plate and the second plate. The locking mechanism may be movable between an unlocked state permitting relative movement between the first plate and the second plate and a locked state restricting relative movement between the first plate and the second plate. The locking mechanism may include at least five pawls that are movable between a first position and a second position to move the locking mechanism between the unlocked state and the locked state.

A seat assembly is provided and may include a seat bottom and a seatback rotatably supported by the seat bottom. A recliner mechanism may be disposed between the seat bottom and the seatback to selectively prevent rotation of the seatback relative to the seat bottom. The recliner mechanism may include a first plate, a second plate, and a locking mechanism associated with the first plate and the second plate. The locking mechanism may be movable between an unlocked state permitting rotation of the seatback relative to the seat bottom and a locked state restricting rotation of the seatback relative to the seat bottom. The locking mechanism may include at least five pawls that are movable between a first position and a second position to move the locking mechanism between the unlocked state and the locked state.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a side view of a round-recliner mechanism in accordance with the principles of the present disclosure;

FIG. 2 is a side view of the round-recliner mechanism of FIG. 1;

FIG. 3 is an exploded view of the round-recliner mechanism of FIG. 1;

FIG. 4 is an exploded view of the round-recliner mechanism of FIG. 1;

FIG. 5 is a side view of the round-recliner mechanism of FIG. 1 with part of a housing removed to show the round-recliner mechanism in a locked state;

FIG. 6 is a side view of the round-recliner mechanism of FIG. 1 with part of a housing removed to show the recliner mechanism in an unlocked state;

FIG. 7 is a schematic representation of a portion of the round-recliner mechanism of FIG. 1 detailing a welding processes used to manufacture the round-recliner mechanism;

FIG. 8 is a schematic representation of a portion of the round-recliner mechanism of FIG. 1 detailing a welding processes used to manufacture the round-recliner mechanism; and

FIG. 9 is a perspective view of a seat assembly incorporating the recliner mechanism of FIG. 1.

### DETAILED DESCRIPTION

The following description is merely exemplary in nature and is not intended to limit the present disclosure, application, or uses. It should be understood that throughout the drawings, corresponding reference numerals indicate like or corresponding parts and features.

With reference to the figures, a recliner mechanism 10 is provided and may include a ratchet plate 12, a guide plate 14, a locking mechanism 16, and an actuation mechanism 18. The locking mechanism 16 may be disposed generally between the ratchet plate 12 and the guide plate 14 and to selectively prevent rotation of the ratchet plate 12 relative to the guide plate 14. The actuation mechanism 18 may be in communication with the locking mechanism 16 to move the locking mechanism 16 between an unlocked state permitting rotation of the ratchet plate 12 relative to the guide plate 14 and a locked state restricting rotation of the ratchet plate 12 relative to the guide plate 14.

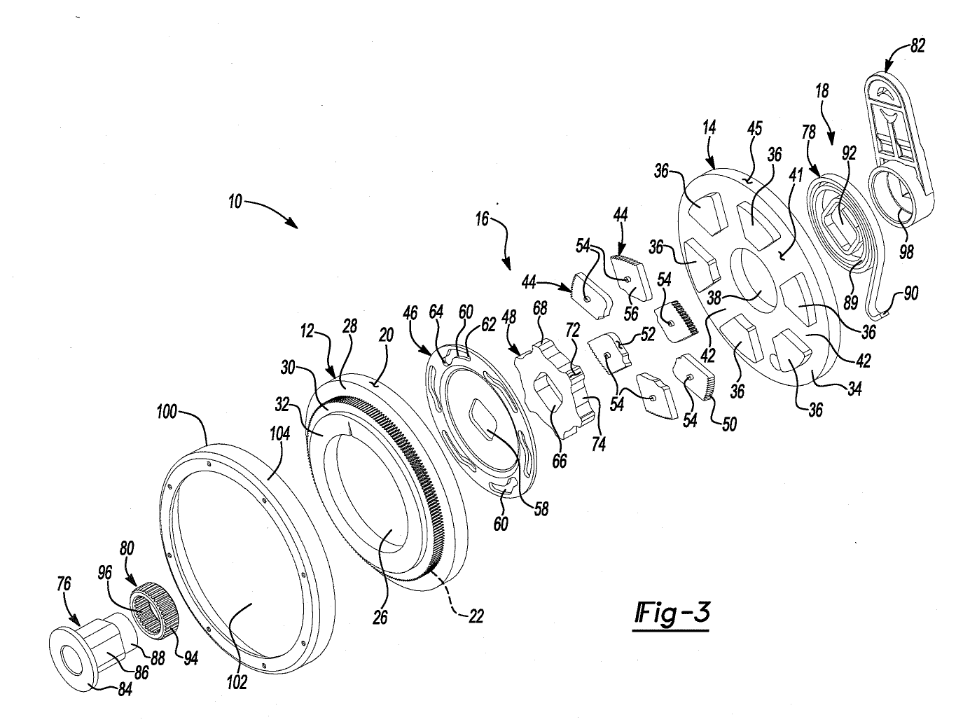

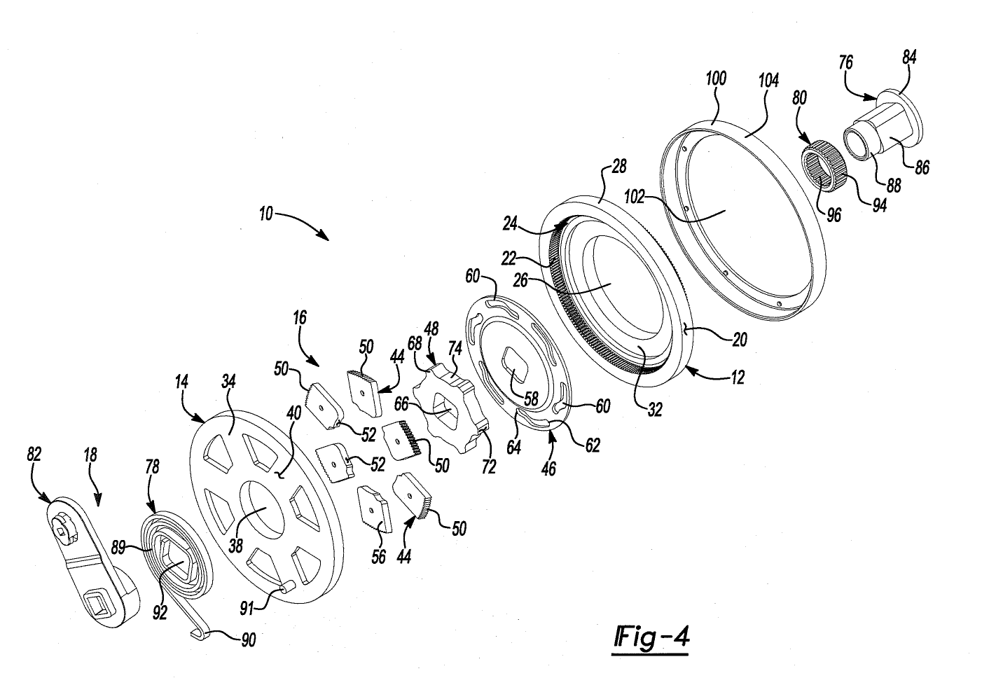

With particular reference to FIGS. 3 and 4, the ratchet plate 12 includes a generally circular shape having an outer surface 20, a series of teeth 22 formed on an inner surface 24 thereof, and a central aperture 26. The ratchet plate 12 may be formed from any suitable process such as, for example, fine blanking. In a first step of such a process, the central aperture 26 may be formed by removing material from a center portion of a blank (not shown) such that a generally circular-shaped disc (not shown) is formed. The circular-shaped disc includes a shape and diameter substantially similar to the central aperture 26.

The ratchet plate 12 may include a stepped profile, whereby the outer surface 20 is formed on an exterior surface of a first-stepped portion 28, the plurality of teeth 22 and inner surface 24 are formed on a second-stepped portion 30, and the central aperture 26 is formed through a third-stepped portion 32, whereby each of the first-stepped portion 28, second-stepped portion 30, and third-stepped portion 32 are formed in successive processes during the fine-blanking process.

The guide plate 14 may include a generally circular shape having a main body 34, a series of projections 36, and a central aperture 38 formed through the main body 34. The main body 34 may include an outer surface 40 and an inner surface 41. The main body 34 and projections 36 may cooperate to form a plurality of recesses 42 that support at least a portion of the locking mechanism 16. Once assembled, the locking mechanism 16 may be disposed generally between the ratchet plate 12 and guide plate 14.

The locking mechanism 16 may be disposed between the ratchet plate 12 and guide plate 14 and may include a plurality of pawls 44, a pawl-retraction plate 46, and a cam 48. While the locking mechanism 16 may include a number of pawls 44 greater than five (5), the locking mechanism 16 will be described hereinafter and shown in the drawings as including six (6) pawls 44.

Each pawl 44 may include a series of teeth 50, an engagement surface 52, and a post 54. The teeth 50 are formed generally on an opposite end of the pawls 44 from the engagement surface 52, while the post 54 extends from a body 56 of the pawls 44 generally between the teeth 50 and the engagement surface 52. Once assembled, the pawls 44 are slidably received within a respective recess 42 formed between a pair of projections 36 of the guide plate 14 to guide movement of the pawls 44 relative to the guide plate 14.

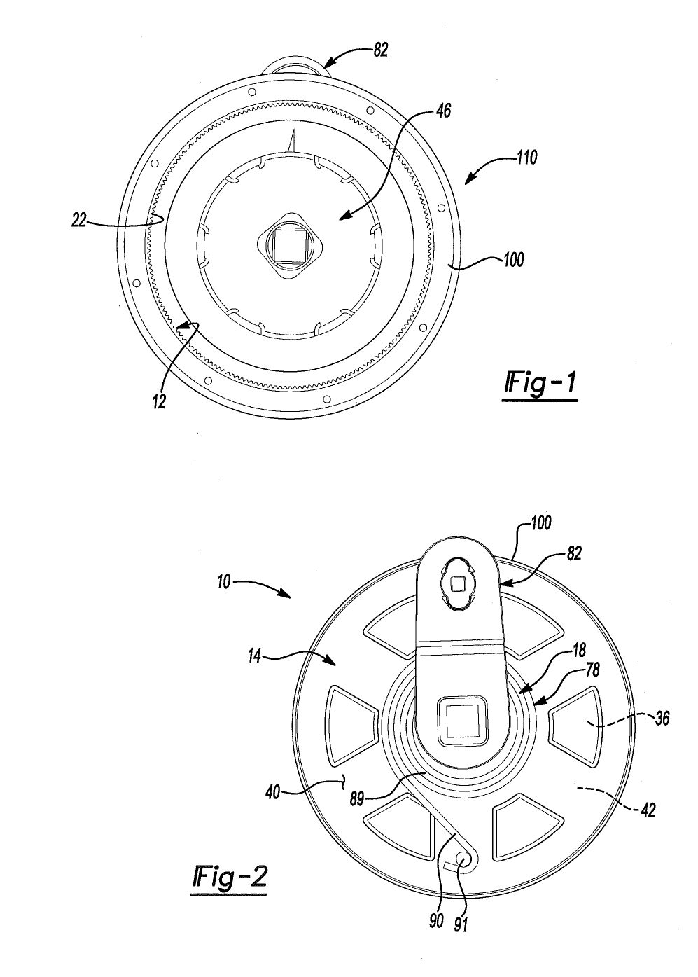

The pawl-retraction plate 46 may be rotatably received between the ratchet plate 12 and guide plate 14 with clearance being provided for the pawl-retraction plate 46 via the stepped portions 28, 30, 32 of the ratchet plate 12. The pawl-retraction plate 46 may include a keyed aperture 58 and a series of peanut (i.e., curved) slots 60 disposed proximate to an outer perimeter of the pawl-retraction plate 46. Each peanut slot 60 includes a first end 62 and a second end 64, whereby the posts 54 of the pawls 44 are respectively received within a peanut slot 60 and are movable generally between the first end 62 and the second end 64. As shown in FIG. 1, the pawl-retraction plate 46 also encloses the recliner mechanism 10 to prevent dirt and other debris from entering the recliner mechanism 10 and concurrently prevents the cam 48 from being removed from the recliner mechanism 10 once the ratchet plate 12 is assembled to the guide plate 14.

The cam 48 may include a keyed aperture 66 and a series of projections 68. The projections 68 may extend from a main body of the cam 48 generally away from the keyed aperture 66. Each projection 68 may include an engagement surface 72 that is in selective engagement with the engagement surfaces 52 of the pawls 44. A series of recesses 74 generally surround the main body 70 of the cam 48 and are disposed between the projections 68.

The actuation mechanism 18 may include a pivot 76, a biasing member 78, a spline ring 80, and an actuation lever 82. The pivot 76 may include an outer flange 84, a keyed body 86, and a cylindrical portion 88 disposed on an opposite end of the pivot 76 from the outer flange 84.

The biasing member 78 may be a coil spring and may include a coiled body 89, an outwardly extending arm 90, and a center portion 92 having a shape that generally mimics the keyed body 86 of the pivot 76. The outwardly extending arm 90 may be attached to a spring post 91 of the guide plate 14 to allow the biasing member 78 to impart a rotational force on the locking mechanism 16, as will be described further below. While the biasing member 78 is described as being a coil spring, the biasing member 78 may be any suitable biasing member that provides a biasing force to the pivot 76 such as, for example, a linear spring.

The spline ring 80 may include a generally circular shape having a series of first splines 94 disposed around an outer perimeter thereof and a series of second splines 96 disposed around an inner perimeter thereof. The second splines 96 may be received by the cylindrical portion 88 of the pivot 76 to fixedly attach the spline ring 80 to the pivot 76. The first splines 94 may be received within a recess 98 of the actuation lever 82 to fixedly attach the spline ring 80 to the actuation lever 82. Because the spline ring 80 is fixedly attached to the pivot 76 via the second splines 96 and is fixedly attached to the actuation lever 82 via the first splines 94, the spline ring 80 fixes the pivot 76 for rotation with the actuation lever 82.

As best shown in FIGS. 2 and 3, the keyed body 86 of the pivot 76 is received within the keyed aperture 58 of the pawl-retraction plate 46, within the keyed aperture 66 of the cam 48, and within the center portion 92 of the biasing member 78. As such, the pawl-retraction plate 46 is fixed for rotation with the pivot 76 while the center portion 92 of the biasing member 78 moves with the pivot 76 when the pivot 76 is rotated relative to the ratchet plate 12 and guide plate 14. Because the outwardly extending arm 90 of the biasing member 78 is fixedly attached to the spring post 91 of the guide plate 14, rotation of the pivot 76 relative to the guide plate 14 causes the coiled body 89 of the biasing member 78 to wind, thereby exerting a force on the locking mechanism 16.

Once the ratchet plate 12 is attached to the guide plate 14 and the various components of the locking mechanism 16 and actuation mechanism 18 are attached to the ratchet plate 12 and guide plate 14, an encapsulation ring 100 may be positioned around an outer surface 45 of the guide plate 14 to maintain engagement between the ratchet plate 12 and the guide plate 14. The encapsulation ring 100 may include a central aperture 102 and a flange 104. The flange 104 may extend over the outer surface 45 of the guide plate 14 and may at least partially extend over the outer surface 20 of the ratchet plate 12.

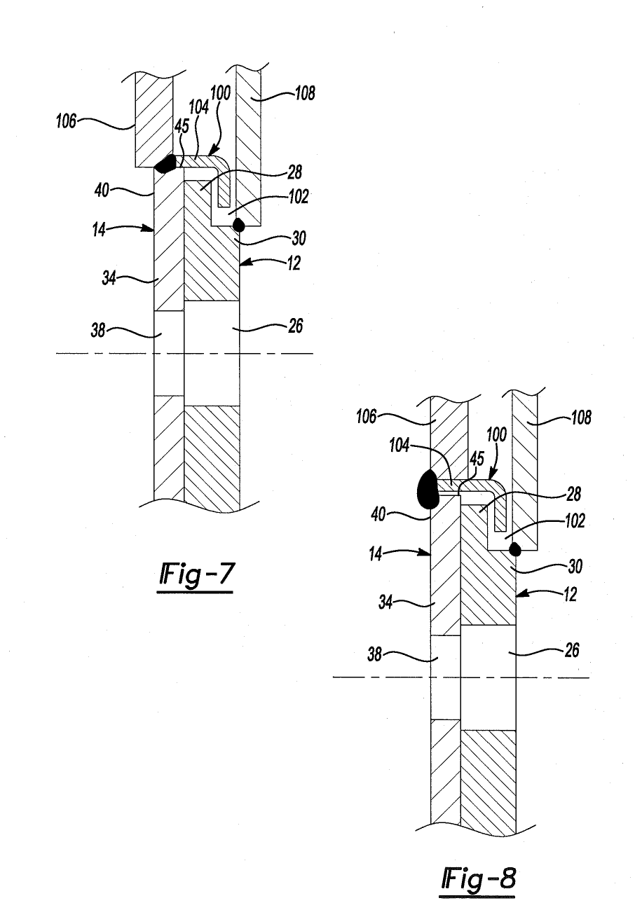

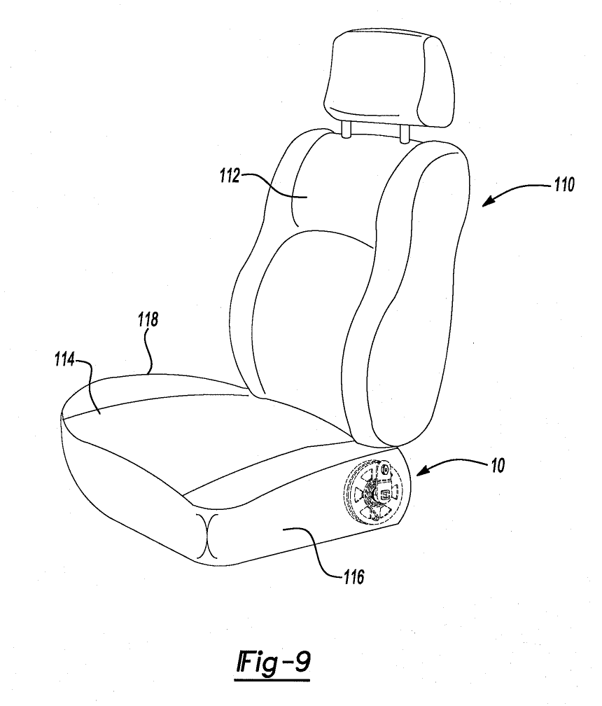

In one configuration, the flange 104 may be fixedly attached to the guide plate 14 and to an external mounting bracket 106 (FIG. 7) via a laser-welding process. Similarly, the ratchet plate 12 may be fixedly attached to a second external mounting bracket 108 (FIG. 8) via at least one of the second-stepped portion 30 and the third-stepped portion 32 using a laser-welding process. While a MIG-welding process is disclosed, the configuration shown in FIG. 8 may allow use of any conventional welding process such as, but not limited to, a TIG-welding process.

While the encapsulation ring 100 is described as being attached to the mounting brackets 106, 108 via a laser-welding process, the encapsulation ring 100 may alternatively be attached to one of the ratchet plate 12 and the guide plate 14 via a MIG-welding process (FIG. 8). If the flange 104 of the encapsulation ring 100 is attached to the guide plate 14 and the external mounting bracket 106 via a MIG-welding process, the flange 104 may be lengthened such that a portion of the flange 104 is substantially flush with and extends to the outer surface 40 of the guide plate 14 and an outer surface of the external mounting plate 106 (FIG. 9). In either welding process, the external mounting bracket 108 is positioned in relation relative to the ratchet plate 12 in a similar fashion. Positioning the flange 104 such that the flange 104 extends generally to the outer surface 40 of the guide plate 14 and to the external surface of the external mounting bracket 106 permits use of the MIG-welding process. Using a MIG-welding process is generally less costly than using a laser-welding process, as MIG welding is more conventional and requires less capital investment.

As described above, the encapsulation ring 100 includes a central aperture 102. During manufacturing of the encapsulation ring 100, a disc-shaped portion (not shown) of the encapsulation ring 100 may be removed. The disc-shaped portion of material removed from the encapsulation ring 100 may be used to form the pawl-retraction plate 46. As such, a cost savings may be realized by forming two components of the recliner mechanism 10 from a single blank of material (not shown), as less material is wasted during the manufacturing process. Similarly, because material is removed from the ratchet plate 12 when the central aperture 26 is formed, a second component may similarly be formed from the disc-shaped material removed from formation of the central aperture 26. For example, the cam 48 of the locking mechanism 16 may be formed from the disc-shaped material removed from the ratchet plate 12 when the central aperture 26 is formed. As described above with respect to the pawl-retraction plate 46, forming the cam 48 from the offal (i.e., scrap) of the ratchet plate 12 similarly reduces material costs by forming two components from a single blank of material.

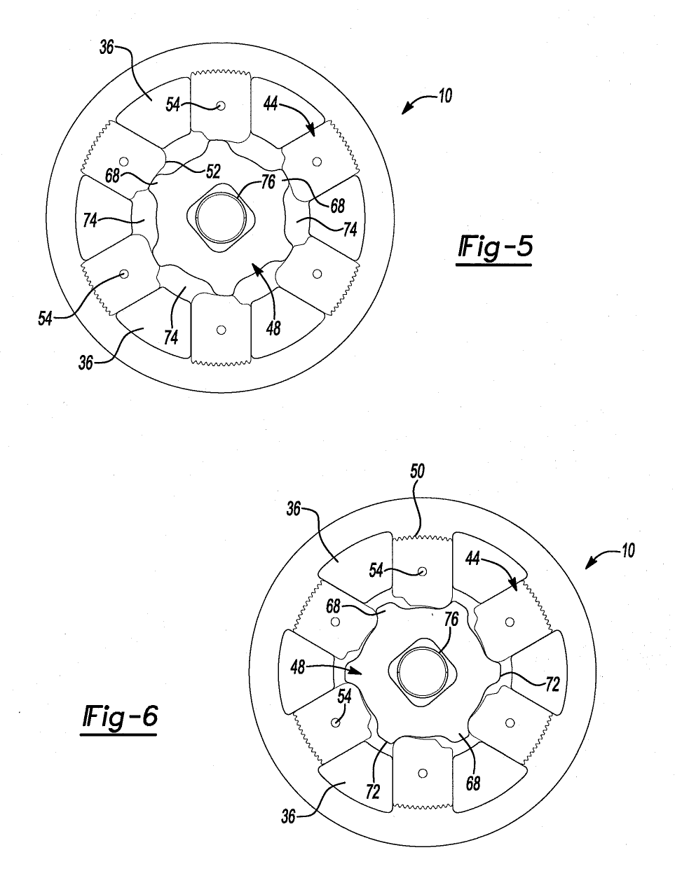

With particular reference to FIGS. 5 and 6, operation of the recliner mechanism 10 will be described in detail. When the recliner mechanism 10 is in the locked state, the pawls 44 are biased into an extended position (FIG. 5), whereby the teeth 50 of each pawl 44 are in meshing engagement with the teeth 22 of the ratchet plate 12. In this position, the ratchet plate 12 is restricted from rotating relative to the guide plate 14 due to engagement between the teeth 50 of the pawls 44 and the teeth 22 of the ratchet plate 12.

The pawls 44 are biased into engagement with the teeth 22 of the ratchet plate 12 by the biasing member 78 of the actuation mechanism 18. Specifically, because the center portion 92 of the biasing member 78 is keyed to the keyed body 86 of the pivot 76 and the outwardly extending arm 90 is attached to the spring post 91 of the guide plate 14, the biasing member 78 exerts a rotational force on the pivot 76. The rotational force exerted on the pivot 76 is also exerted on the cam 48, as the keyed aperture 66 of the cam 48 receives the keyed body 86 of the pivot 76. Similarly, the rotational force exerted on the pivot 76 is transferred to the pawl-retraction plate 46, as the keyed aperture 58 of the pawl-retraction plate 46 is also fixed for rotation with the pivot 76 via engagement between the keyed body 86 of the pivot 76 and the keyed aperture 58 of the pawl-retraction plate 46.

The force exerted on the cam 48 via the pivot 76 causes the cam 48 to be biased in the clockwise direction relative to the view shown in FIG. 5. Rotation of the cam 48 in the clockwise direction relative to the view shown in FIG. 5 causes the engagement surfaces 72 of each projection 68 to engage the respective engagement surfaces 52 of each pawl 44 to urge each pawl 44 generally toward and into engagement with the teeth 22 of the ratchet plate 12.

Because the pawl-retraction plate 46 is similarly rotated in the clockwise direction relative to the view shown in FIG. 5, the slots 60 are positioned to allow the post 54 to move toward the first end 62 and away from the second end 64 to provide clearance for the cam 48 to urge each pawl 44 generally toward the teeth 22 of the ratchet plate 12 and into a locked position. Once the pawl-retraction plate 46 and cam 48 are sufficiently rotated in the clockwise direction relative to the view shown in FIG. 5, the posts 54 of each pawl 44 traverse each slot 60 and move toward the first end 62 until the teeth 50 of each pawl 44 engage the teeth 22 of the ratchet plate 12. At this point, the teeth 50 of each pawl 44 are in engagement with the teeth 22 of the ratchet plate 12 and rotation of the ratchet plate 12 relative to the guide plate 14 is restricted.

In this position, the recliner mechanism 10 is in the locked state and rotation of the ratchet plate 12 relative to the guide plate 14 is restricted. In one configuration, each of the pawls 44 includes twelve teeth. In this configuration, a total of seventy-two (i.e., six pawls 44×twelve teeth per pawl 44) teeth 50 are engaged with the teeth 22 of the ratchet plate 12.

A force may be applied to the actuation lever 82 to move the recliner mechanism 10 from the locked state to the unlocked state. For example, a force may be applied to the actuation lever 82 against the bias exerted thereon by the biasing member 78 to cause rotation of the pivot 76 in the counterclockwise direction relative to the view shown in FIG. 6. Rotation of the pivot 76 in the counterclockwise direction relative to the view shown in FIG. 6 causes similar rotation of the pawl-retraction plate 46 and cam 48 in the counterclockwise direction relative to the view shown on FIG. 6.

Rotation of the pawl-retraction plate 46 in the counterclockwise direction relative to the view shown in FIG. 6 causes the peanut slots 60 to move relative to the posts 54 of each pawl 44. Movement of the slots 60 relative to the posts 54 causes the posts 54 to move generally away from the first end 62 of each slot 60 and toward the second end 64 of each slot 60 due to the shape of each slot 60. Rotation of the cam 48 in the counterclockwise direction relative to the view shown in FIG. 6 moves the projections 68 out of engagement with the engagement surface 52 of each pawl 44 and causes the recesses 74 of the cam 48 to oppose the engagement surfaces 52 of each pawl 44. As such, when the pawl-retraction plate 46 rotates in the counterclockwise direction relative to FIG. 6 and the slots 60 cause movement of the posts 54 of each pawl 44 from the first end 62 of each slot 60 to the second end 64 of each slot 60, the pawls 44 are pulled away from the teeth 22 of the ratchet plate 12 due to the clearance afforded by the recesses 74 of the cam 48 (FIG. 6). In this position, the teeth 50 of each pawl 44 are removed from engagement with the teeth 22 of the ratchet plate 12. As such, rotation of the ratchet plate 12 relative to the guide plate 14 is permitted.

Once the force applied to the actuation lever 82 is released, the biasing member 78 is once again permitted to apply a biasing force on the actuation lever 82 and pivot 76. As described above, the biasing member 78 applies a rotational force on the pivot 76 in the clockwise direction relative to the view shown in FIG. 5. Applying a force to the pivot 76 in the clockwise direction relative to the view shown in FIG. 5 causes the pivot 76 to similarly rotate the pawl-retraction plate 46 and cam 48 in the clockwise direction relative to the view shown in FIG. 5. As described above, once the pawl-retraction plate 46 and cam 48 are sufficiently rotated in the clockwise direction relative to the view shown in FIG. 5, the teeth 50 of each pawl 44 engage the teeth 22 of the ratchet plate 12 to restrict rotation of the ratchet plate 12 relative to the guide plate 14. When the ratchet plate 12 is prevented from rotating relative to the guide plate 14, the recliner mechanism 10 is returned to the locked state.

With particular reference to FIG. 9, the recliner mechanism 10 is shown installed into a seat assembly 110. The seat assembly 110 may include a seatback 112 rotatably supported by a seat bottom 114. The recliner mechanism 10 may be installed in the seat assembly 110 generally at a junction of the seatback 112 and the seat bottom 114. The ratchet plate 12 may be fixedly attached to the seatback 112 while the guide plate 14 may be fixedly attached to the seat bottom 114. While the ratchet plate 12 is described as being attached to the seatback 112 and the guide plate 14 is described as being attached to the seat bottom 114, the ratchet plate 12 may alternatively be attached to the seat bottom 114 and the guide plate 14 may alternatively be attached to the seatback 112.

When the recliner mechanism 10 is moved into the unlocked state, the ratchet plate 12 is permitted to rotate relative to the guide plate 14. When the ratchet plate 12 is permitted to rotate relative to the guide plate 14, the seatback 112 is similarly permitted to rotate relative to the seat bottom 114. When the recliner mechanism 10 is returned to the locked state, the ratchet plate 12 is no longer permitted to rotate relative to the guide plate 14. As such, the seatback 112 is similarly restricted from rotating relative to the seat bottom 114.

The recliner mechanism 10 may be disposed on an inboard side 116 of the seat assembly 110 and may also be positioned on an outboard side 118 of the seat assembly 110. If a pair of recliner mechanisms 10 are provided such that one recliner mechanism 10 is positioned at the inboard side 116 of the seat assembly 110 and another recliner mechanism 10 is positioned at the outboard side 118 of the seat assembly 110, a cross rod (not shown) may extend between the recliner mechanisms 10. The cross rod may transmit a rotational force applied to the actuation lever 82 at the recliner mechanism 10 disposed at the outboard side 118 of the seat assembly 110 to the recliner mechanism 10 disposed at the inboard side 116 of the seat assembly 110 to release the recliner mechanism 10 disposed at the inboard side 116 of the seat assembly 110 at substantially the same time that the recliner mechanism 10 disposed at the outboard side 118 of the seat assembly 110 is released.

Because the recliner mechanism 10 may be positioned at the inboard side 116 or the outboard side 118 of the seat assembly 110, the actuation lever 82 may be positioned proximate to an outer surface of either the ratchet plate 12 or the guide plate 14. For example, while the outer flange 84 of the pivot 76 is shown as being disposed proximate to an outer surface of the ratchet plate 12 and the actuation lever 82 is shown as being disposed proximate to the outer surface 40 of the guide plate 14, the outer flange 84 of the pivot 76 could alternatively be in close proximity to the outer surface 40 of the guide plate 14 while the actuation lever 82 could be disposed proximate to an outer surface of the ratchet plate 12. In either configuration, the keyed body 86 of the pivot 76 is fixed for rotation with the pawl-retraction plate 46, cam 48, center portion 92 of the biasing member 78, and the actuation lever 82. The recliner mechanism 10 is moved between the locked state and the unlocked state by selectively applying a rotational force to the actuation lever 82, as described above.

What is claimed is:

1. A recliner mechanism comprising:
a first plate;
a second plate; and
a locking mechanism associated with the first plate and the second plate and movable between an unlocked state permitting relative movement between said first plate and said second plate and a locked state restricting relative movement between said first plate and said second plate, said locking mechanism including at least five pawls movable between a first position and a second position to move said locking mechanism between said unlocked state and said locked state.

2. The recliner mechanism of claim 1, wherein said locking mechanism includes a cam rotatable relative to said first plate and said second plate, said cam selectively moving said at least five pawls from said unlocked state to said locked state.

3. The recliner mechanism of claim 1, wherein said locking mechanism includes a biasing member that biases said at least five pawls into said second position.

4. The recliner mechanism of claim 1, wherein said locking mechanism includes a pawl-retraction plate rotatably supported relative to said first plate and said second plate and operable to move said at least five pawls between said first position and said second position.

5. The recliner mechanism of claim 4, wherein said pawl-retraction plate is in slidable engagement with said at least five pawls to move said at least five pawls between said first position and said second position.

6. The recliner mechanism of claim 4, wherein said pawl-retraction plate includes at least five slots respectively associated with said at least five pawls, said at least five pawls respectively received within said at least five slots and movable within said at least five slots between a first end and a second end.

7. The recliner mechanism of claim 6, wherein rotation of said pawl-retraction plate relative to said first plate and said second plate causes slideable movement of said at least five pawls within said at least five slots.

8. The recliner mechanism of claim 4, wherein each of said at least five pawls includes a post slidably received within respective ones of said at least five slots.

9. The recliner mechanism of claim 1, further comprising an encapsulation ring received around an outer surface of one of said first plate and said second plate to hold said first plate and said second plate in engagement.

10. The recliner mechanism of claim 9, wherein said encapsulation plate is fixedly attached to at least one of said first plate and said second plate by at least one of a MIG weld and a laser weld.

11. The recliner mechanism of claim 1, further comprising a pivot rotatably received within said first plate and said second plate to selectively move said at least five pawls between said first position and said second position.

12. The recliner mechanism of claim 11, further comprising an actuation handle fixed for rotation with said pivot to move said at least five pawls between said first position and said second position.

13. The recliner mechanism of claim 12, further comprising a spline ring disposed between said pivot and said actuation handle to fix said actuation handle to said pivot.

14. The recliner mechanism of claim 1, wherein said locking mechanism includes six pawls.

15. A seat assembly comprising:
a seat bottom;
a seatback rotatably supported by said seat bottom; and
a recliner mechanism disposed between said seat bottom and said seatback to selectively prevent rotation of said seatback relative to said seat bottom, said recliner mechanism comprising:
a first plate;
a second plate; and
a locking mechanism associated with said first plate and said second plate and movable between an unlocked state permitting rotation of said seatback relative to said seat bottom and a locked state restricting rotation of said seatback relative to said seat bottom, said locking mechanism including at least five pawls movable between a first position and a second position to move said locking mechanism between said unlocked state and said locked state.

16. The seat assembly of claim 15, wherein said locking mechanism includes a cam rotatable relative to said first plate and said second plate, said cam selectively moving said at least five pawls from said first position to said second position.

17. The seat assembly of claim 15, wherein said locking mechanism includes a biasing member that biases said at least five pawls into said second position.

18. The seat assembly of claim 15, wherein said locking mechanism includes an pawl-retraction plate rotatably supported relative to said first plate and said second plate and operable to move said at least five pawls between said first position and said second position.

19. The seat assembly of claim 18, wherein said pawl-retraction plate is in slideable engagement with said at least five pawls to move said at least five pawls between said first position and said second position.

20. The seat assembly of claim 18, wherein said pawl-retraction plate includes at least five slots respectively associated with said at least five pawls, said at least five pawls respectively received within said at least five slots and movable within said at least five slots between a first end and a second end.

21. The seat assembly of claim 20, wherein rotation of said pawl-retraction plate relative to said first plate and said second plate causes slideable movement of said at least five pawls within said at least five slots.

22. The seat assembly of claim 18, wherein each of said at least five pawls includes a post slidably received within respective ones of said at least five slots.

23. The seat assembly of claim 15, further comprising an encapsulation ring received around an outer surface of one of said first plate and said second plate to hold said first plate and said second plate in engagement.

24. The seat assembly of claim 23, wherein said encapsulation plate is fixedly attached to at least one of said first plate and said second plate by at least one of a MIG weld and a laser weld.

25. The seat assembly of claim 15, further comprising a pivot rotatably received within said first plate and said second plate to selectively move said at least five pawls between said locked first position and said second position.

26. The seat assembly of claim 25, further comprising an actuation handle fixed for rotation with said pivot to move said at least five pawls between said first position and said second position.

27. The seat assembly of claim 26, further comprising a spline ring disposed between said pivot and said actuation handle to fix said actuation handle to said pivot.

28. The seat assembly of claim 15, wherein said locking mechanism includes six pawls.
